(19) United States
(12) Patent Application Publication
(10) Pub. No.: US 2003/0192770 A1
(43) Pub. Date: Oct. 16, 2003

(54) Machine for feeding bases and lids of cans containing food preserves, industrial products or the like for closing machines

(75) Inventor: Gustavo Rodriguez De Cepeda Y Lopez, Coslada (ES)

Correspondence Address: COLLARD & ROE, P.C., 1077 Northern Boulevard, Roslyn, NY, 11576-1696, US

(73) Assignee: M B HISPACAN, S.A.

(21) Appl. No.: 10/271,191

(22) Filed: Oct. 15, 2002

(30) Foreign Application Priority Data
Apr. 16, 2002 (EP) 02 380 080.8

(51) Int. Cl. B65G 29/00

(52) U.S. Cl. 198/624

(57) ABSTRACT

Machine that allows supplying bases and lids for cans containing preserves, industrial products or aerosols automatically and without using pneumatic means, allowing to adjust the machine to the different diameters of the bases and lids without having to disassemble them, for which it is provided with three shafts or spindles (1) arranged concentrically with a 120° separation to each other and further comprising regulation means based on a slide or guide (3); additionally, on each shaft or spindle (1) is a pulley (2) joined to a servomotor (7) by a transmission belt (6) so that each revolution of the motor supplies a base or lid to the carrier disc (9).

### OBJECT OF THE INVENTION

The object of the present invention is a machine for feeding bases and lids of cans containing food preserves, industrial products or the like for closing machines. It specifically relates to a machine that allows supplying the bases and lids used in the industry for cans containing food, paints or varnishes or for the tops or bases of aerosols, with said bases and lids being supplied automatically.

The machine object of the present invention is characterised in that it allows a fast adaptation to the different diameters of the bases and lids that must be supplied without requiring to disassemble the machine.

Also an object of the present invention is developing a machine that does not require pneumatic means for its operation and that does not require any adjustment of the stopping function when it detects the absence of a body.

Thus, the present invention lies in the field of machines used to supply bases and lids used in both the food industry and in the supply of the end elements of aerosols and the like, for closing machines.

### BACKGROUND OF THE INVENTION

Machines presently available in the market have a number of disadvantages, such as that not allowing a simple adjustment of the base and lid-feeding machine to the various sizes required without having to disassemble the machine.

In addition, all current machines use pneumatic systems, with the resulting high cost of the machine and increased maintenance difficulty. Furthermore, given the reliability of the machine disclosed it is not necessary to adjust the body absence function.

There also exist cases in which the curling of bases and lids to be supplied is out of range, so that the machines have problems processing these bases and lids.

The object of the present invention is therefore to overcome the above disadvantages by developing a machine that does not require pneumatic actuation at all, that can adjust quickly to the different diameters without requiring to disassemble the machine and which can be adjusted for the cases where the curling is out of range, and in which there is not stoppage at all due to the body absence signal.

### DESCRIPTION OF THE INVENTION

The machine object of the invention consists of a feeding machine that can be used for several diameters. It comprises three spindles or shafts arranged regularly about a central axis, with a 120° separation between each other. Each spindle or shaft is mounted on a slide or guide so that the distance from the shaft or spindle to the centre about which they are mounted can vary, thereby allowing the bases and lids that will be placed in the inner space defined by the three shafts or spindles to have different diameters.

The top part of the machine has a central ring provided with three orifices for the guide bars, which bars will calibrate the diameter of the base or lid to be supplied and will serve as a linking mean to the carrier means.

A pulley is provided on each shaft or spindle. The three pulleys of the shafts or spindles are connected to a servomotor by a transmission belt.

The servomotor operates by turning the three pulleys of the shafts or spindles, so that with each turn of the servomotor a complete revolution of each pulley of the shafts or spindles is caused, and a base or lid is supplied. This is achieved by a cam provided on the bottom of the shafts or spindles, the shape of the cam being such that at a specific point and after a complete revolution of the servomotor the lid or base is supplied.

When the base and lid-feeding machine has supplied a base or lid, said base or lid will fall by gravity onto a carrier disc where it is retained by magnetic means. Said transport disc is provided with fingers that push the base or lid and distribute it into the corresponding niche or orifice of a feeding star.

### DESCRIPTION OF THE DRAWINGS

In order to complement the description and to help understand the characteristics of the invention, according to a preferred embodiment, the description is accompanied by a set of drawings where for purposes of illustration and in a non-limiting sense the following is represented:

FIG. 1 shows a plan view of the machine for feeding bases and lids for closing machines.

FIG. 2 shows a cross-section of the feeding machine along the line A-A.

FIG. 3 shows the feeding machine assembly with the conveyor belt and the feeding star.

### PREFERRED EMBODIMENT OF THE INVENTION

In view of the aforementioned figures a preferred embodiment of the invention is described below, as well as an explanation of the drawings.

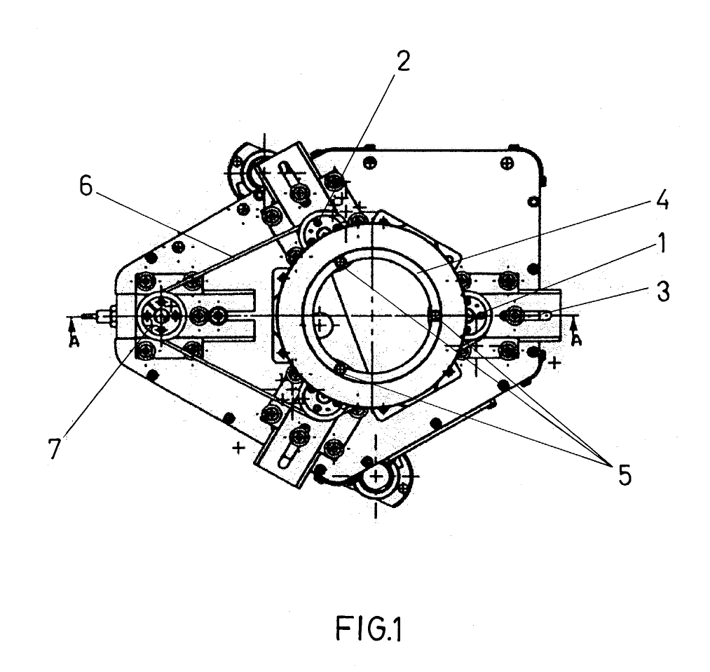

FIG. 1 shows how the feeding machine for bases and lids of preserve cans or the like is provided with a number of shafts or spindles (1) arranged concentrically with a 120° separation between each other.

Each shaft or spindle (1) can move with respect to the centre on which they are mounted, as they are mounted on a guide or slide (3) which allows them to be separated or approached depending on the diameter of the bases and lids supplied.

On each shaft or spindle is placed a pulley (2), with all the pulleys being joined by a transmission belt that is in turn joined to a servomotor (7).

As the servomotor (7) turns, and by means of the transmission belt (6), it turns the pulleys (2) of the shafts or spindles (1) so that each revolution of the servomotor (7) causes one revolution of each pulley (2) and a base or lid to be supplied.

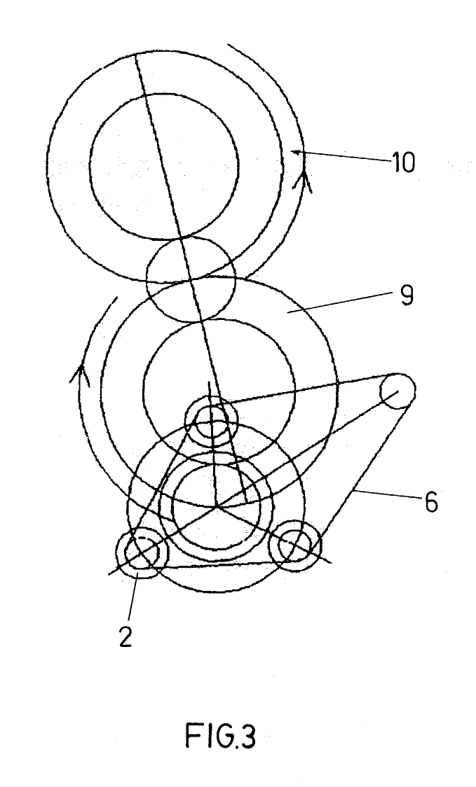

On the top of the machine is a central ring (4) provided on its perimeter with guide bars (5), which with the guide or slide (3) allow calibrating the diameter of the bases and lids to be supplied. Additionally, said guide bars (5) serve as a linking means between the feeding machine and the carrier disc (9) (FIG. 3).

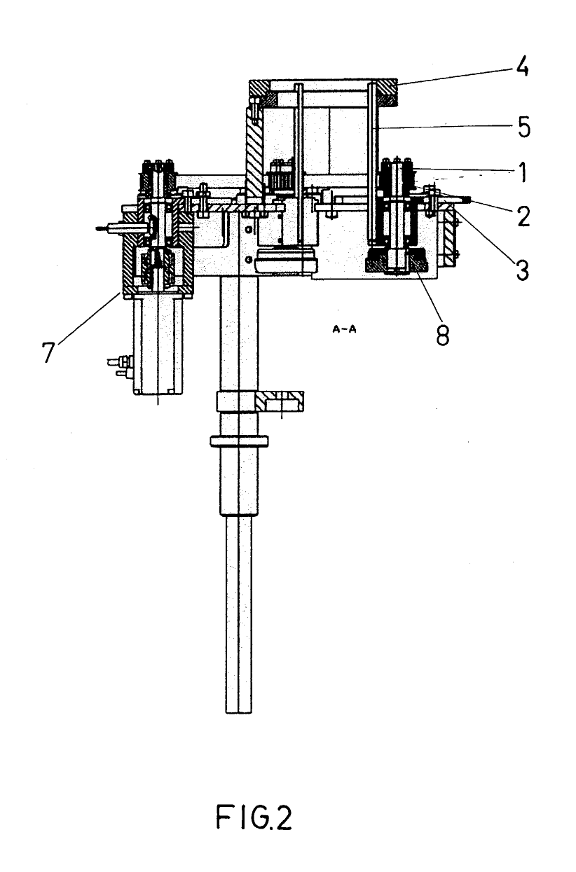

FIG. 2 shows all of the above details, further revealing that provided on the end of the shafts or spindles (1) are cams (8) which present a shape and arrangement such that with revolution of their pulleys (2) they assume a position that allows supplying a base or lid.

FIG. 3 shows how the feeding machine is arranged above the carrier disc (3), onto which the bases or lids fall by gravity and where they are retained by magnetic means or the like. It is also provided with fingers that push the bases and lids into each of the housings of the feeding star (10).

It is not considered necessary to extend this description any further to allow an expert in the field to understand the scope of the invention and the advantages derived thereof.

The materials, shape, size and arrangement of the component elements may vary as long as the essence of the invention is not affected.

The terms used in this description shall be understood in a wide and non-limiting sense.

1. Feeding machine for bases and lids of cans containing preserves, industrial products or the like, for closing machines, characterised in that it allows supplying the bases and lids used for preserve cans or aerosol cans automatically without using pneumatic means, allowing adjusting to the various diameters of bases and lids without having to disassemble the machine, and adaptable to curling out of range, for which it is provided with shafts or spindles (1) arranged concentrically and separated 120° to each other, with said shafts or spindles (1) having pulleys (2), provided with adjustment means.

2. Feeding machine for bases and lids of cans containing preserves, industrial products or the like, for closing machines, according to claim 1, characterised in that said pulleys are joined to a servomotor (7) by means of a transmission belt (6).

3. Feeding machine for bases and lids of cans containing preserves, industrial products or the like, for closing machines, according to claim 1, characterised in that said adjustment means are based on guides or slides (3) that allow to adapt the machine to the diameter of the bases and lids supplied.

4. Feeding machine for bases and lids of cans containing preserves, industrial products or the like, for closing machines, according to claim 1, characterised in that a central ring (4) is placed above the machine that has three orifices provided for the guide bars (5), allowing calibration of the diameters of the bases and lids and acting as an interface between the machine and the carrier disc (9).

5. Feeding machine for bases and lids of cans containing preserves, industrial products or the like, for closing machines, according to claim 1, characterised in that on the ends of the shafts or spindles (1) are cams (8) that allow supplying the bases and lids.

6. Feeding machine for bases and lids of cans containing preserves, industrial products or the like, for closing machines, according to claim 4, characterised in that the carrier disc (9) is provided with magnetic retention means for holding the bases and lids, and is also provided with fingers that push the bases and lids into each housing provided on the feeding star (10).

7. Feeding machine for bases and lids of cans containing preserves, industrial products or the like, for closing machines, according to claim 4, characterised in that the carrier disc (9) is provided with fingers that push the bases and lids into each housing provided on the feeding star (10).

8. Feeding machine for bases and lids of cans containing preserves, industrial products or the like, for closing machines, according to claim 2, characterised in that each revolution of the servomotor (7) results in a revolution of each pulley (2) of the shafts or spindles (1) and in the supply of a base or lid.
